(19) United States
(12) Patent Application Publication
(10) Pub. No.: US 2015/0038027 A1
(43) Pub. Date: Feb. 5, 2015

(54) Amphibious Vehicle

(71) Applicant: YOUNG CHAN PARK, Gyeonggi-do (KR)

(72) Inventor: YOUNG CHAN PARK, Gyeonggi-do (KR)

(21) Appl. No.: 14/447,420

(22) Filed: Jul. 30, 2014

(30) Foreign Application Priority Data
Jul. 31, 2013 (KR) 10-2013-0090928
Jul. 10, 2014 (KR) 10-2014-0086824

(51) Int. Cl. B60F 3/00

(52) U.S. Cl. CPC B60F 3/0038; B60F 3/0007
USPC 440/12.66; 440/12.5

(57) ABSTRACT

An amphibious vehicle is capable of traveling on water by controlling a manipulation panel installed in the vehicle when the vehicle moves from land to water or from water to land. The vehicle includes a pair of piston propellers that are mounted on a lower surface of a rear bumper of a vehicle body, and configured to operate with crossing each other to push back water on a water surface while moving from up to down upon a rotation in one direction, wherein the pair of piston propellers comprises: a pair of first and second motors that are configured to generate preset driving forces, respectively, according to a control of a manipulation panel installed in the vehicle body; first and second crankshafts that are rotated in a predetermined direction, in response to operations of the pair of first and second motors; and first and second cylinders that are connected and fixed to end portions of first and second connecting rods, respectively, and configured to form linear motion paths of first and second pistons executing linear reciprocating motions.

### CROSS REFERENCE TO RELATED CO-PENDING APPLICATIONS

This application claims the benefit of Korean Patent Application Serial No. 10-2013-0090928 filed Jul. 31, 2013 and entitled “AMPHIBIOUS VEHICLE”, the contents of which are expressly incorporated herein by reference.

This application claims the benefit of Korean Patent Application Serial No. 10-2014-0086824 filed Jul. 10, 2014 and entitled “AMPHIBIOUS VEHICLE”, the contents of which are expressly incorporated herein by reference.

### FIELD OF THE INVENTION

The present invention relates to an amphibious vehicle, which is capable of being converted from ground movement into a movement on water, in a manner of taking down a bellows floating body, which is detachably provided on a lower surface of the vehicle, and of driving vertical floating bodies for rescue and piston propellers upon operating on water.

### BACKGROUND OF THE INVENTION

In general, an amphibious vehicle refers to a vehicle which is provided with wheels or a caterpillar for traveling on land, and a structure for cruising on water (i.e., a structure having buoyancy and propelled by propellers or web plates).

Korean Publication Patent No. 2010-0087535 (Aug. 5, 2010) has disclosed a simplified amphibious vehicle using a rubber boat, which is allowed to be movable even on water, such as rivers and oceans, as well as on land, in a manner of employing the rubber boat which is detachably provided on a lower surface of the vehicle.

However, in such prior art, a user (a driver or an operator) suffers from inconvenience in view of having to attach the rubber boat on the lower surface of the vehicle to use the vehicle on water and having to detach the rubber boat to use the vehicle on land.

To overcome such inconvenience, Korean Publication Patent No. 2010-0133520 has disclosed an amphibious vehicle, which is capable of moving at very fast speed in water by installing a pair of propellers on a lower surface of the amphibious vehicle, of having an improved rotation capacity by being allowed for 360° rotation to left/right in a stopped state, and of ensuing mobility by being allowed to be moved back at fast speed even upon backing up the vehicle.

However, in such prior art, a propulsion apparatus in which the propellers are accommodated has a fixed height. Accordingly, cavitation is generated in water when water is rotated. The cavitation frequently causes damages on the propellers. Here, the cavitation refers to a phenomenon that pressure of a liquid at a specific point is lowered than atmospheric pressure of the liquid at that moment while the liquid flows, such that air and vapor within the liquid are separated so as to form air bubbles and vacuum.

Consequently, it is required to develop a rescue vehicle body 100 in a simplified form, which the general public can easily mount under situations that water damages are frequently caused due to regional torrential rains, which frequently result from global warming.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

To overcome those drawbacks of the prior art, an aspect of the detailed description is to provide an amphibious vehicle, capable of being applied to vehicles, which are currently produced or on sale, in a very convenient manner at low prices.

Another aspect of the detailed description is to provide an amphibious vehicle, capable of extending lifespan of components of the vehicle, by avoiding an occurrence of cavitation while the vehicle is driven on water, in a manner of installing a pair of piston propellers at a rear bumper of the vehicle.

An amphibious vehicle according to the preferred embodiment disclosed herein may include a pair of piston propellers that are mounted on a lower surface of a rear bumper of a vehicle body, and configured to operate with crossing each other to push back water on a water surface while moving from up to down upon rotation in one direction; a pair of first and second motors that are configured to generate preset driving forces, respectively, according to a control of a manipulation panel installed in the vehicle body; first and second crankshafts that are rotated in a predetermined direction, in response to operations of the pair of first and second motors; and first and second cylinders that are connected and fixed to end portions of first and second connecting rods, respectively, and configured to form linear motion paths of first and second pistons executing linear reciprocating motions.

An amphibious vehicle according to the present disclosure may have the following effects.

First, the amphibious vehicle disclosed herein may have a simple structure which is very conveniently applied to land vehicles which are currently produced or on sale, and can be implemented with low installation costs and without a driver's attachment or detachment of additional components or elements.

Therefore, even if the vehicle is fell into or crashed from land into water, it can easily travel as a rescue vehicle on water, and also the driver may drive the vehicle from land into water for the purpose of leisure.

Second, while the vehicle is driven on water, cavitation may not be caused during the driving on water, by virtue of a pair of piston propellers installed at a rear bumper of the vehicle, thereby extending lifespan of components of the vehicle.

Therefore, since a propeller which is installed in general amphibious vehicles is not used, frequent breakdown or replacement of components may be minimized. This may result in a reduction of maintenance costs.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

The above and/or other aspects of the present invention will be more apparent by describing certain exemplary embodiments of the present invention with reference to the accompanying drawings, in which:

FIG. 1 is a perspective view illustrating an overall appearance of an amphibious vehicle in accordance with the preferred embodiment disclosed herein;

FIG. 2 is a view illustrating a construction of piston propellers of the amphibious vehicle in accordance with the preferred embodiment disclosed herein;

FIG. 3 is a view illustrating a construction of steering keys of the amphibious vehicle in accordance with the preferred embodiment disclosed herein;

FIG. 4 is a view illustrating an operation of a front wing rod part of the amphibious vehicle in accordance with the preferred embodiment disclosed herein;

FIG. 5 is a view illustrating an operation of a bellows floating body of the amphibious vehicle in accordance with the preferred embodiment disclosed herein;

FIG. 6 is a view illustrating a process in which a paddle sole robot pulls a cable down from a rear bumper and then extends the cable up to a front bumper across a bottom surface of a bellows floating body to surround the bellows floating body;

FIG. 7 is a view illustrating an operation of the steering keys of the amphibious vehicle in accordance with the preferred embodiment disclosed herein;

FIG. 8 is a view illustrating an operation of a central weight of magnetic air balls located within the bellows floating body of the amphibious vehicle in accordance with the preferred embodiment disclosed herein;

FIG. 9 is a view illustrating an operation of gravity and buoyancy of a horizontal floating body of the amphibious vehicle in accordance with the preferred embodiment disclosed herein;

FIG. 10 is a view illustrating an operation of the horizontal buoyant bodies of the amphibious vehicle in accordance with the preferred embodiment disclosed herein;

FIG. 11 is a view illustrating an operation that a paddle palm arm of a robot-head adsorption plate and a paddle sole leg of a cross-shaped adsorption plate, which are stuck on a magnetic member with being hung upside down on a bottom surface of the bellows floating body in response to walking of the paddle sole robot of the amphibious vehicle are horizontally moved by horizontal and vertical movements;

FIG. 12 is a detailed view of cables 450 and 730;

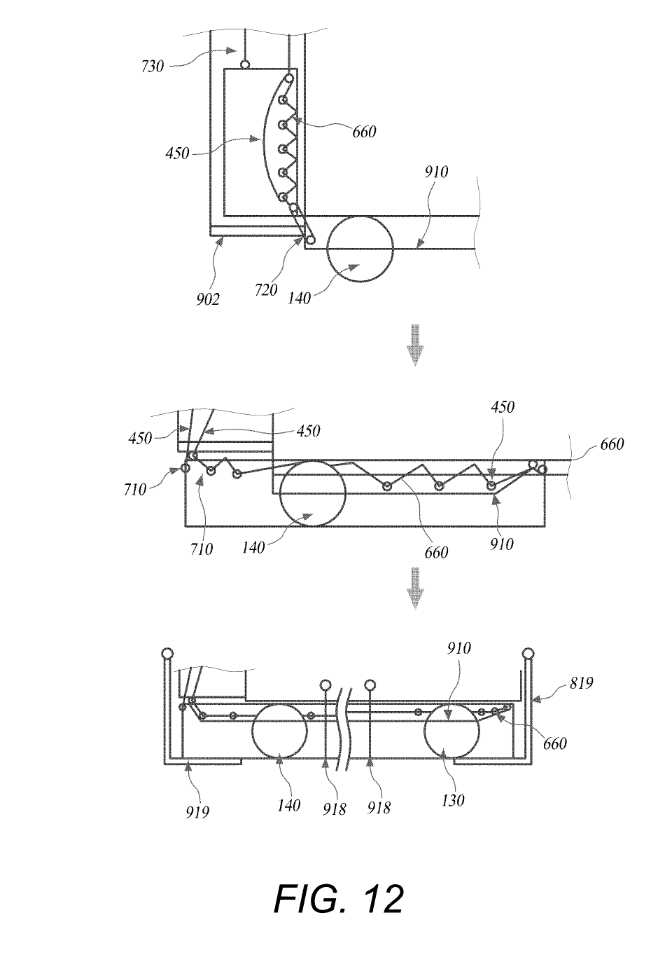

FIG. 13 illustrates side views of the operation of a bellows floating body of the amphibious vehicle; and

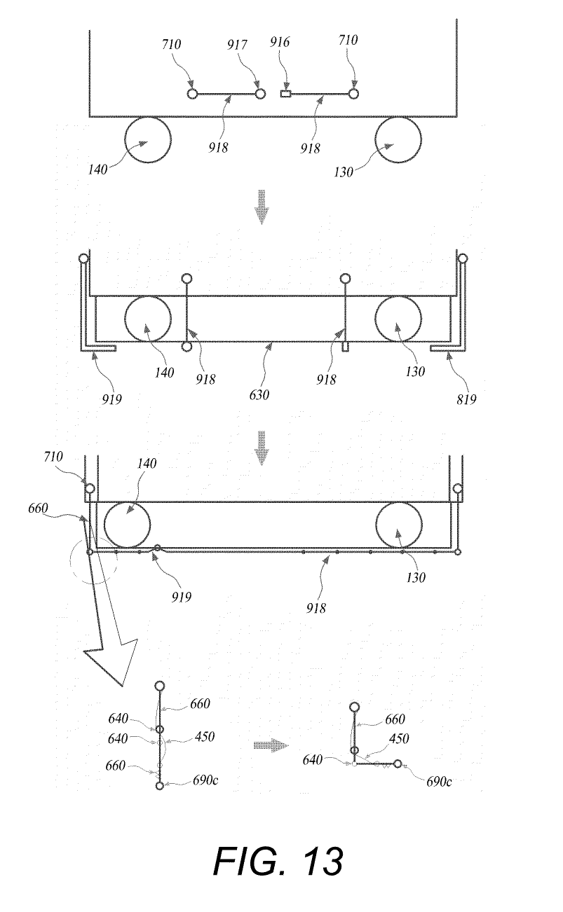

FIG. 14 is a detailed view of pulleys 710.

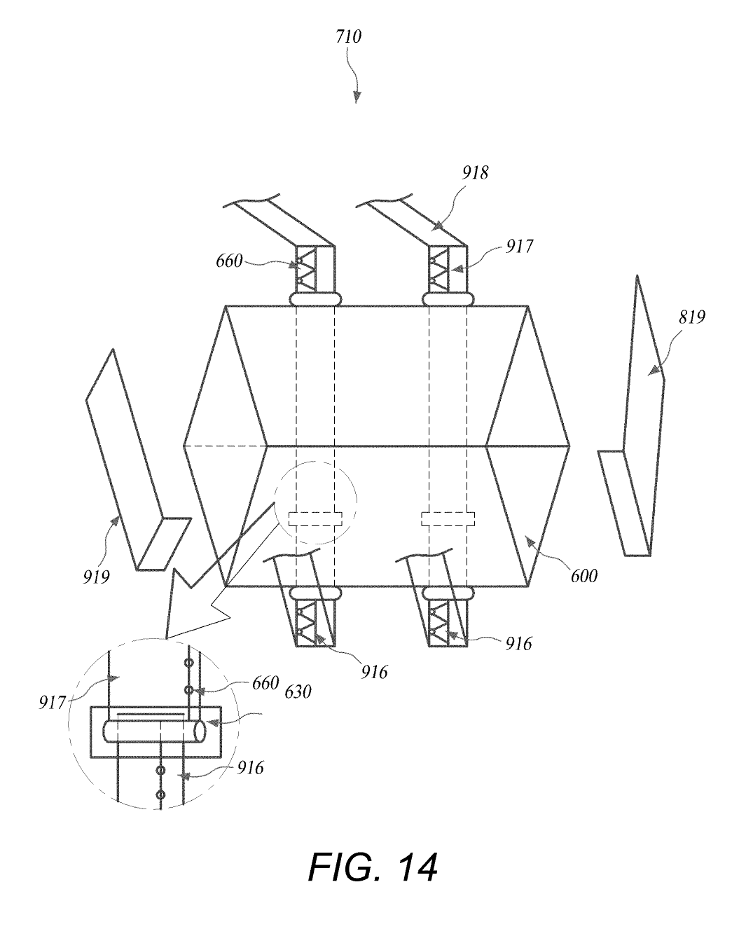

### DETAILED DESCRIPTION OF THE INVENTION

Hereinafter, description will be given in detail of some embodiments of the present disclosure with reference to the illustrative drawings. In providing reference numerals to elements of each drawing, it should be understood that the same numerals are provided to the same elements, if possible, although those elements are illustrated in different drawings. Also, in describing the present invention, moreover, the detailed description will be omitted when a specific description for publicly known technologies to which the invention pertains is judged to obscure the gist of the present invention. Also, the terms including, first, second, A, B, (a), (b), etc. can be used to describe various elements. The terms are used merely for the purpose to distinguish an element from the other element, but may limit nature, sequence or order of the corresponding elements.

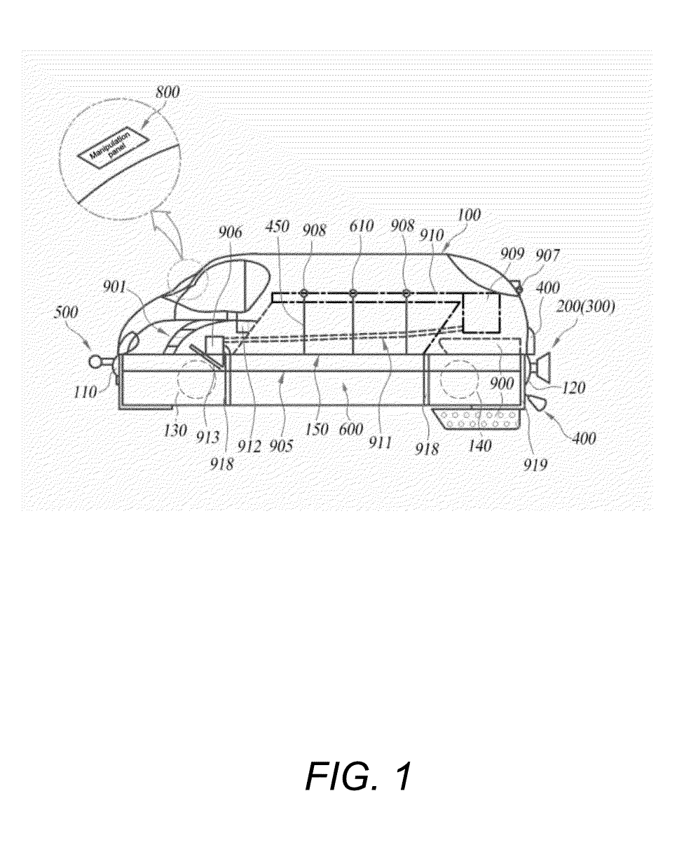

FIG. 1 is a perspective view illustrating an overall appearance of an amphibious vehicle in accordance with the preferred embodiment disclosed herein.

An amphibious vehicle according to the preferred embodiment disclosed herein may include a pair of piston propellers 200 and 300 that are mounted on a lower surface of a rear bumper 120 of a vehicle body 100 and operate with crossing each other to push back water on a water surface while moving from up to down in a rotating manner in one direction; a pair of steering keys 400 that are provided on left and right bottom surfaces of the rear bumper 120, which is located between the pair of piston propellers 200 and 300, and adjust a moving direction to be perpendicular to a proceeding direction of the vehicle body 100 according to a user's control; a front wing bar part 500 that is provided on a lower surface of a front bumper 110 of the vehicle body 100 and extends forward according to a user's manipulation; a bellows floating body 600 that is provided between front wheels 130 and rear wheels 140 of the vehicle body 100, which are located on a bottom of a side sill panel 150 of the vehicle body within the vehicle body 100 according to the user's control, and extends toward the front bumper 110 and the rear bumper 120 to cover the front wheels 130 and the rear wheels 140 of the vehicle; a paddle sole robot 800 that is installed on a central portion of a lower surface of the bellows floating body 600 in a proceeding direction of the vehicle body 100 and surrounds front and rear portions of the bellows floating body of the vehicle body 100 according to the user's control so as to form a support; a pair of horizontal buoyant bodies 700 that are installed at left and right side surfaces of a rear side of the vehicle body 100 so as to adjust a weight of the bellows floating body 600 by filling magnetic air balls 903 in the bellows floating body 600 and adjust buoyancy of the bellows floating body 600 by taking out the magnetic air balls 903, and that are converted into underwater mats by being drawn down; and a manipulation panel 900 that is located within the vehicle body 100 and selectively controls operations of the pair of piston propellers 200 and 300, the steering keys 400, the front wing bar part 500, and the bellows floating body 600.

As illustrated in FIG. 1, an exhaust port 907 which is connected to an engine installed at the front wheels 130 of the vehicle body may extend to an upper end between the rear of a driver seat 160 and the bellows floating body 600 to be located at a rear side below a roof of the vehicle body. This may allow the vehicle to freely operate on land and on water.

Also, electric hoists 908 (a machine for conveying a heavy object up and down), which are connected to a guide rail 901 installed on an upper end of a rear underwater electric motor 909, may allow the bellows floating body 600 to be moved up and down while being hung on the guide rail 910, and the bellows floating body 600 may be mounted on the bottom of the vehicle body 100. The electric hoist 908 may be selected from one or more fixed pulleys, one movable pulley having a hook or a similar coupling member, and a compound pulley which is a set of single ropes.

Also, when a power take off (PTO) gear 906 provided at the manipulation panel 900 is driven at the driver seat 160, a driving force of the engine which is installed at the front wheels 130 may be transferred up to the rear end through side surfaces of the bottom of the driver seat 160, so as to drive the rear underwater electric motor 909, the bellows floating body 600, the piston propellers 200 and 300, the steering keys 400, the horizontal buoyant bodies 700, the front wing bar part 500, side members 919 and the paddle sole robot 800, which are all connected by a driving shaft 911. An upper gear and a middle gear which are connected with the underwater electric motor by joints at a left side of the driver seat 160 may always be maintained in a connected state. Then, when the PTO gear 906 is activated, the left middle gear may be moved inward such that the first submerged electric motor 909 connected to a lower main gear can be driven.

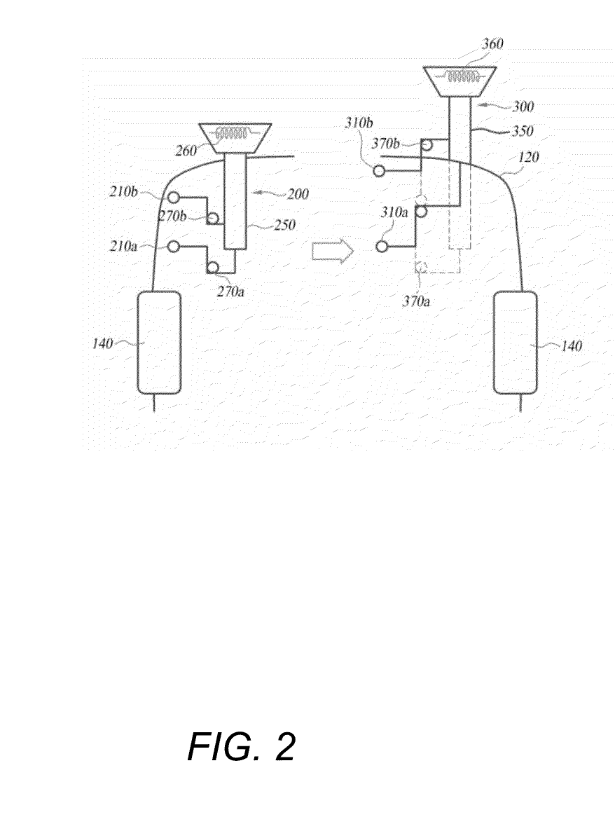

Here, upon entrance from land into water, if a cable is unrolled (released), the bellows floating body 600 which is located in the vehicle body 100 may be drawn down and unfolded in a left-right horizontal direction to extend and be mounted to bottoms of the front bumper 110 and the rear bumper 120. Also, the side members 919 may be drawn down from the front bumper 110 and the rear bumper 120, respectively, so as to cover and support front and rear portions of the bellows floating body 600. In response to the activation of the first submerged electric motor 909, it may be inspected that paddle sole legs and paddle soles, which are provided on cross-shaped adsorption plates of the paddle sole robot 800, move horizontally and vertically along a ceiling and walls to mount cables so as to cover and support the bellows floating body 600. Accordingly, the vehicle may proceed into water. When the vehicle is traveling on the water surface, the vehicle may be driven by manipulating the piston propellers 200 and 300 and the steering keys 400. When the cables are rolled upon switching from the traveling on water to the traveling on land, the paddle sole robot may move backward and the cables may be released by being rolled from the front bumper to the rear bumper, such that the bellows floating body 600 can be lifted up into the vehicle body 100 for storage. This may allow for the ground traveling of the vehicle. The bellows floating body 600 may be lifted up into the vehicle body 100 for storage, which may allow the vehicle to freely operate on land. Here, the pair of piston propellers 200 and 300, as illustrated in FIG. 2, may include a pair of second and third motors 210a, 210b, 310a and 310b which generate preset driving forces according to the control of the manipulation panel 900 installed in the vehicle body 100, first and second crankshafts 270a, 270b, 370a and 370b which are rotated in a predetermined direction by the pair of second and third motors 210a, 210b, 310a and 310b, first and second connecting rods (not illustrated) which are connected and fixed to the first and second crankshafts 270a, 270b, 370a and 370b to convert the rotary motion of the first and second crankshafts 270a, 270b, 370a and 370b into a linear motion, first and second cylinders 250 and 350 which are connected and fixed to end portions of the first and second connecting rods to form linear reciprocating paths of first and second pistons which execute the linear reciprocating motion, and first and second laminar flow forming coils 260 and 360 which generate magnetism in a predetermined direction for stabilizing a surrounding turbulent flow into the laminar flow when a current flows.

In FIG. 2, the crankshafts 270a, 270b, 370a and 370b and the connecting rods (not illustrated) are belts, each in a shape of a band, which are held on two machine wheels to fix a central portion and a rear portion of each of the first and second cylinders 250 and 350, such that a driving force of one shaft can be transferred to another shaft.

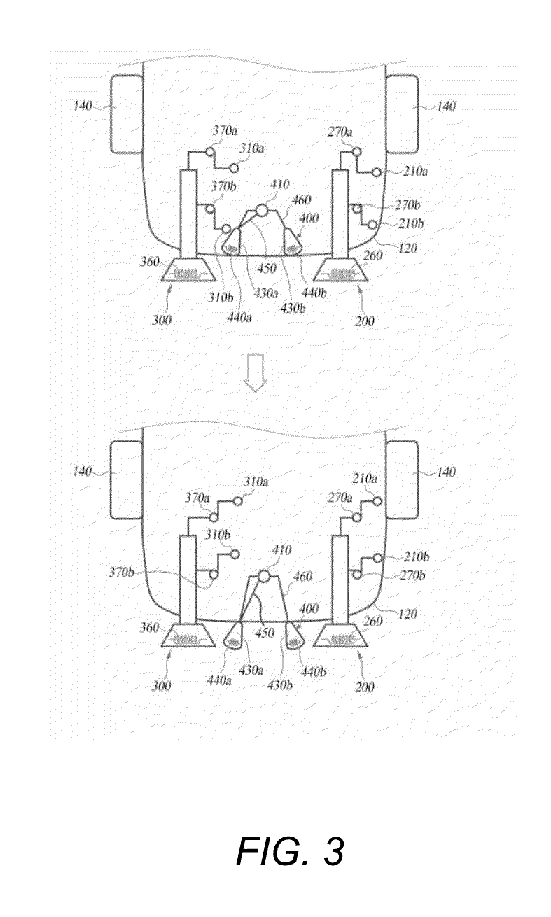

The steering keys 400, as illustrated in FIG. 3, may include a fourth motor 410 which generates a preset driving force according to the control of the manipulation panel 900, a pair of steering keys 430a and 430b which are movable in an up-and-down direction by a pair of cables 450 and 460, in response to driving of the fourth motor 410, so as to steer a travel direction of the vehicle body 100, and a pair of fourth laminar flow forming coils 440a and 440b which generate magnetism in a predetermined direction for stabilizing a surround turbulent flow into the laminar flow when a current flows, so as to facilitate the pair of steering keys 430 and 430b to adjust the travel direction.

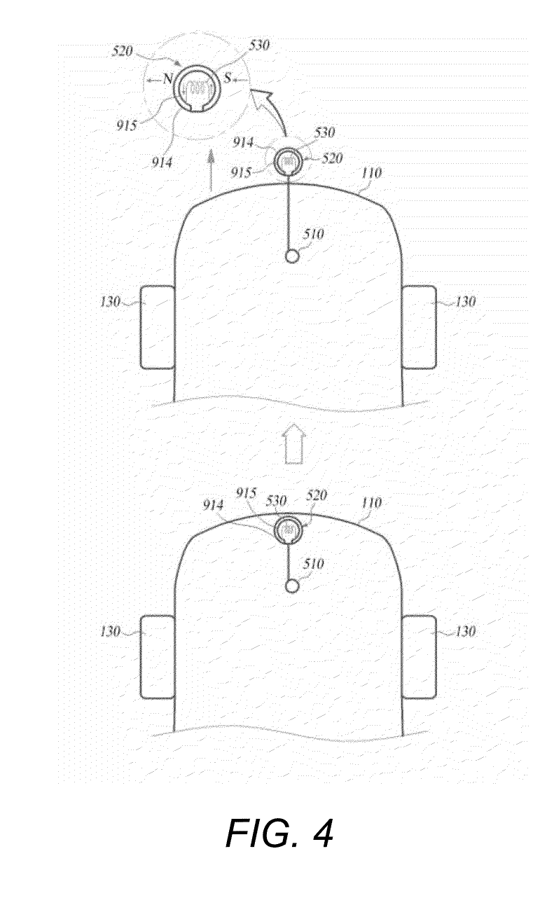

The front wing rod part 500, as illustrated in FIG. 4, may include a fifth motor 510 which generates a preset driving force according to the control of the manipulation panel 900, a front wing rod 520 which is extendable to the front by driving the fifth motor 510, and a fifth laminar flow forming coil 530 which generates magnetism in a predetermined direction for stabilizing a surrounding turbulent flow into the laminar flow when a current flows.

Here, it may be noticed that a current flows upward along a coil-wound direction. Since a line of magnetic force flows to left, a left side is N-pole and a right side is S-pole. Also, since a magnetic field (around a magnet) flows from N-pole into S-pole at the outside of the coil, a loop-current magnetic field is formed. Accordingly, the turbulent flow becomes a conductor to be converted into a laminar flow.

Here, the front wing rod 520 may be fabricated in a shape of a circular ring which protrudes to the front of the vehicle body 100 into a shape of a wing, which may allow a great current to flow such that the turbulent flow can be converted into the laminar flow.

Here, the front wing rod 520 may include an electric circular coil, an electric motor 914, an electric heater motor, a temperature-adjusting element, a tourmaline 915, and a cable 650.

The electric heater (an electric bar which is put into water to boil the water), which is mounted in a shape of a circular frame of the front wing rod 520, does not cause an electric shock but can adjust temperature because of having a high voltage but a low current. The electric heater is an electric bar which increases temperature of water by being put in the water and laminarizes a turbulent flow of the water by convection of the water.

The convection refers to the transfer of heat by a flow of fluid which is generated due to a difference of temperature. Waves which are partially heated become light to come up toward a top by buoyancy, and upper cold waves move down to absorb heat of the electric heater 914. In such a manner, as the waves flow up and down, the water is laminarized.

Whether or not the electric heater is operating may be checked by a white plume phenomenon caused due to joining of the electric heater 914 and cold waves (i.e., a phenomenon that drops of water looking like white smoke are generated). The convection generated by the front wing rod 520 and the electric motor 914 may make the turbulent flow changed into the laminar flow. This may result in reduction of speed and friction of water, thereby increasing a travel speed of the vehicle. The tourmaline 915 which is in the form of a circular belt and mounted in the front wing rod 520 continuously generates a current. When the current comes in contact with waves, electricity may be generated so as to instantaneously dissolve water. The tourmaline 915 is an ore which is composed of a plus electrode and a minus electrode. When the tourmaline 915 is put into water for a predetermined time (for about 5 minutes), the water is alkalized.

By using the property of generating electricity, the tourmaline 915 makes a current flow on waves to laminarize the turbulent flow.

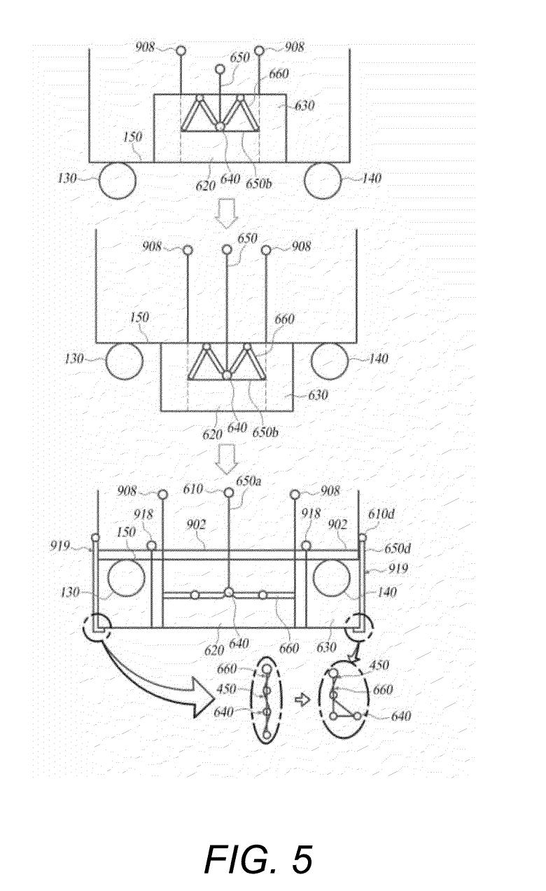

Also, the bellows floating body 600, as illustrated in FIG. 5, may include a sixth motor 610 which generates a preset driving force according to the control of the manipulation panel 900, a floating member 630 which extends down by a predetermined length while being mounted in the side sill panel 150 of the vehicle body 100 by a linear reciprocating motion of the sixth motor 610, and a bellows structure 620 which is installed in the floating member 630 and extends the floating member 630 in a horizontal direction by a preset distance, in response to the operation of the sixth motor 610.

Here, the side sill panel 150 is a footstool which replaces a frame at a lower end portion of a side surface of the vehicle body 100.

Referring to FIG. 5, pulleys 710 of locker arms 720 of the side members 919, which are erected vertically from the bottoms of the front bumper 110 and the rear bumper 120, may be bent in a horizontal direction to face the bellows floating member 600. Accordingly, the side members 919 may cover and support the bellows floating member 600.

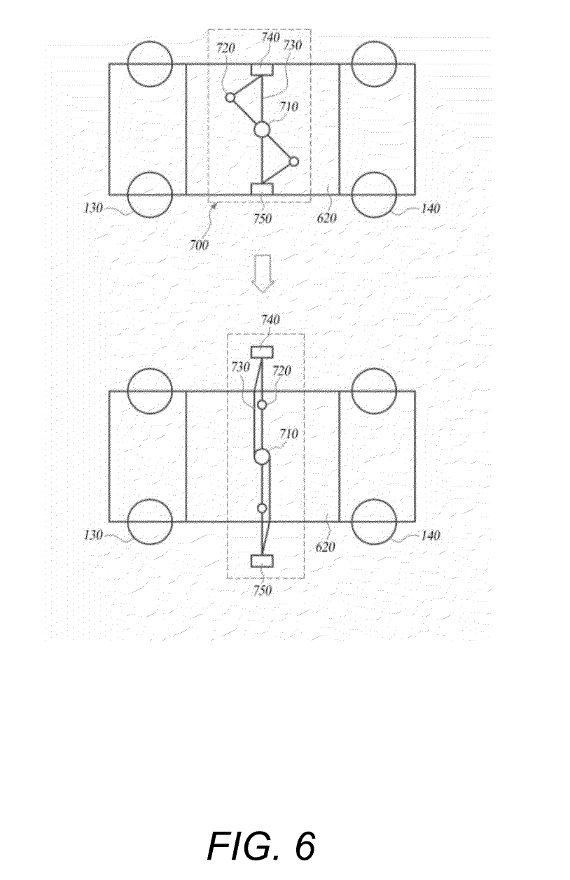

The paddle sole robot, as illustrated in FIG. 6, is an unmanned traveling vehicle, in which a magnetic member is installed across front and rear surfaces based on the side members, which are perpendicularly drawn down from the front and rear bumpers, and a center of a bottom surface of the bellows floating body, an inductive cable is disposed to execute a detection using a current thereof, and a determination function such as a ultrasonic sensor or a computer is provided so as to move forward in a self-erected state. The paddle sole robot 800 may include as axes cross-shaped adsorption plates which are hung on a ceiling, like a spider, and extend horizontally. Each adsorption plate may be provided with two paddle sole legs 802, each of which may be provided with four paddle soles 801. Each adsorption plate may execute a horizontal movement while moving horizontally and vertically. Simultaneously, a robot head adsorption plate may be provided with paddle palm arms 804 at both sides thereof. Each paddle palm arm may be provided with four paddle palms 803. The robot head adsorption plate may be fixed and execute a horizontal movement as the paddle palm arms and the paddle palms are stretched forward and pulled up.

Such robot which uses the electromagnet may be attachable merely onto a magnetic member, and independently travel and stop even on a tilt surface without a help of an external structure.

A double safety device, such as connecting a safety line to the robot, may preferably be applied in preparation of power cutoff or the change of external work environments. Ultrasonic sensors 805 which are provided at front and rear surfaces of the robot may be used to measure a distance between the side members 919 and the bellows floating body 600, such that the robot can move to a center of the bellows floating body 600. An infrared sensor module may be used to avoid an obstacle when the obstacle is detected in front of the robot. Also, a magnetic sensor head may be produced by using a hall sensor and a permanent magnet 920. An electromagnetic cable may be connected to a rear end of the electromagnetic robot.

A cable-climbing robot employing a landing method of the paddle sole legs 802, which are movable along an inductive cable 809, may be designed and fabricated, and a control program for monitoring and controlling the robot in various devices may be installed and executed.

Four platforms of the paddle sole robot 800 may be provided with a robot controller, a motor, hardware required to be assembled with a robot chassis, an infrared line tracking sensor, an infrared receiver which is used for infrared and far infrared communications for avoiding an obstacle, paddle soles 801, paddle sole legs 802, an optical sensor, and a motor encoder disposed for speed control. Each platform of the paddle sole robot 800 may be programed in advance to simply carry out a preset operation of moving horizontally and vertically by being stuck on the magnetic member installed on the centers of the ceiling and wall surfaces, so as to be movable only to a prearranged position.

Electromagnetic cables 690a may be mounted in a manner that a cable attached to the paddle sole robot 800 covers the bellows floating body 600, and a cable installed at the rear bumper 120 is released, extends perpendicularly along the magnetic member and the inductive cable 809 inserted in the side members 919, then extends horizontally by being stuck on a ceiling of a lower surface of the bellows floating body 600, and extends up perpendicularly to the side members 919 installed at the front bumper.

Upon a release of the electromagnetic cables 690a, the cable may be released at the front bumper and simultaneously rolled at the rear bumper, such that a current can flow along the magnetic member and the inductive cable. The paddle sole robot 800 may detect the current flow through the ultrasonic sensor. The robot 800 may thus move backward to the lower surface of the bellows floating body 600, and then move to the rear bumper, thereby being stored in a robot storage rack 810.

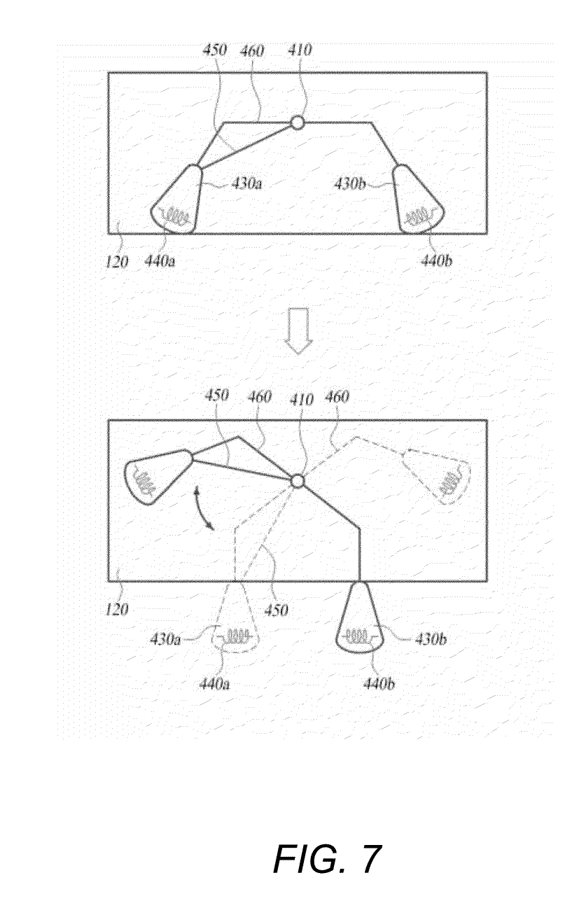

Hereinafter, an operation of the pair of pump steering keys 430a and 430b will be described with reference to FIG. 7. When a cable 450 connected to the left steering key 430a is released in response to driving of the fourth motor 410, the left steering key 430a which is located at the left side may be brought down and disposed in water. Here, the right steering key 430b which is located at a diagonal direction to the left steering key 430b may be moved from up to down. On the other hand, when the cable 450 which is connected to the left steering key 430a is pulled in response to the driving of the fourth motor 410, the right steering key 430b may be brought down and disposed in the water. Here, the left steering key 430a which is located at the diagonal direction may be moved from down to up.

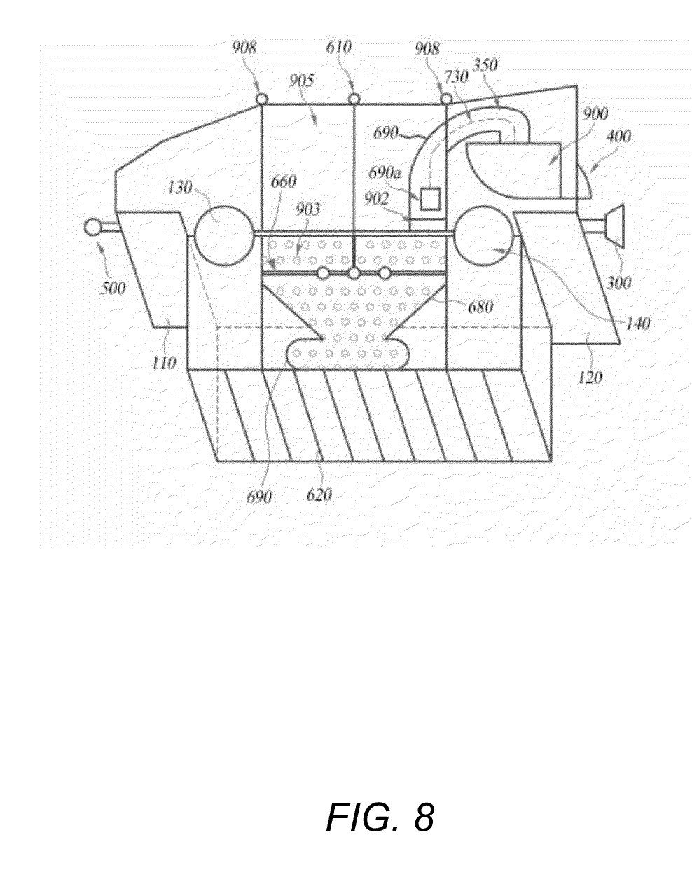

Referring to FIG. 8, a cylinder 690 may be installed on a bottom of a central portion within the bellows floating body 600, and magnetic air balls 903 may form a weight 680 within the cylinder 690.

When the vehicle body 100 is tilted forward or backward or to left or right by waves or the like, since the weight 680 installed in the cylinder 690 returns to an original position according to the law of inertia, a weight of the vehicle body 100 may be lowered in a downward direction. This may result in preventing the vehicle 110 from being tilted in all directions.

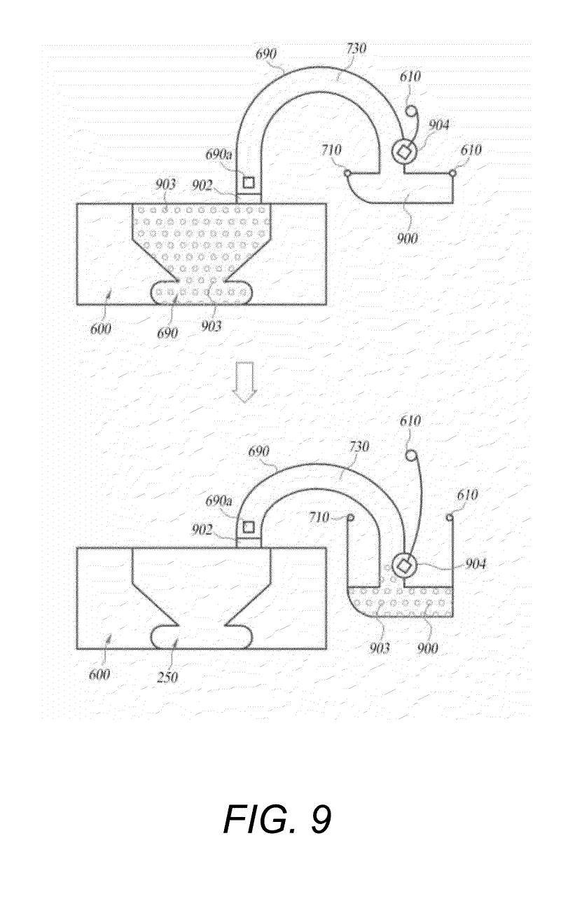

Therefore, the weight 680 of the magnetic air balls 903 and the cylinder 690 illustrated in FIG. 8 may be installed on the inner bottom surface of the bellows floating body 600, and the bellows structure 620 and the plurality of locker arms 660 illustrated in FIG. 5 may be installed thereabove. A magnetic door 902 and the electromagnetic cable 690a illustrated in FIG. 8 may be installed on the structure 620 and the locker arms 660. Referring to FIG. 9, when the electromagnetic cable 690a which is located within the cylinder 690, adjacent to an inlet of the bellows floating body 600, generates a magnetic force, the magnetic air balls 903 may be concentrated onto the inlet side of the bellows floating body 600 so as to stick to the electromagnetic cable 690a.

The magnetic air balls 903 may stick to one another by the magnetic force of the electromagnetic cable 690a, which are located adjacent position to the inlet of the bellows floating body 600. As the electromagnetic cable 690a is rolled by an electric motor, the magnetic air balls 903 may be moved by the magnetic force. A ring 904 may be installed in the cylinder 690 in an interconnected manner at an adjacent position to an inlet of the horizontal floating body 700. The electromagnetic cable 690a may then be inserted through the ring 904 attached to the inlet of the horizontal floating body 700. Since the magnetic air balls 903 are greater than the ring 904 in size, the magnetic air balls 903 cannot pass through the ring 904. Accordingly, the magnetic air balls 903 may be separated from the electromagnetic cable 690a to be dropped down. The magnetic air balls 903 may thus be stored in the lower horizontal floating body 700. This may result in an increase in buoyancy of the vehicle body 100.

When a magnetic force is generated from another electromagnetic cable 690b within the cylinder 690, adjacent to an inlet of the horizontal floating body 700, the magnetic air balls 903 may be gathered toward the inlet of the horizontal floating body 700, thereby sticking to the another electromagnetic cable 690b which is not connected to the ring. The magnetic air balls 903 may stick together by the magnetic force of the electromagnetic cable 690b. As the another electromagnetic cable 690b connected to a second electric motor is rolled, the magnetic air balls 903 stuck together may be moved toward the inlet of the bellows floating body 600 by the magnetic force. Here, when a flow of a current is cut off, the electromagnetic cable 690b may lose the magnetic force. The magnetic air balls 903 which have stuck to the electromagnetic cable 690b may be dropped into the bellows floating body 600 and stored therein. Consequently, the weight of the vehicle body 100 may be adjusted.

Here, when the electromagnetic cable 690b located within the cylinder 690 touches the permanent magnet door 902 which is located at the inlet of the bellows floating body 600, the permanent magnet door 902 may be automatically opened and closed. Here, the inlet of the bellows floating body 600 and the inlet of the horizontal floating body 700 may be connected to each other through the cylinder 690, thus forming a shape of one long bag. Therefore, in order for the vehicle body 100 to rise up to a water surface, the magnetic air balls 903 which are stored in the bellows floating body 600 may be transferred into the horizontal floating body 700 for storage therein by the electromagnetic cable 690a. The horizontal floating body 700 may then be drawn down to come in contact with water, and then converted into the underwater mat so as to increase the buoyancy. The weight of the vehicle body 100 may be adjusted by filling the magnetic air balls 903 in the bellows floating body 600 which is located at the bottom of the vehicle body 100, and the buoyancy of the vehicle body 100 may be adjusted by taking the magnetic air balls 903 out of the bellows floating body 600, thereby freely controlling the vehicle body 100 to be submerged and rise up to the water surface.

When the magnetic air balls 903 within the bellows floating body 600 are taken out of the vehicle body 100, namely, when the magnetic air balls 903 are drawn out of the vehicle body 100 by converting the horizontal buoyant bodies 700, which are located at left and right surfaces of the rear side of the vehicle body 100, into the underwater mats, the weight of the vehicle body 100 may be reduced and the buoyancy may become greater than gravity, thereby allowing the vehicle body 100 to float on water.

In order to submerge the amphibious vehicle, the underwater mats may be converted back into the horizontal buoyant bodies 700. The horizontal buoyant bodies 700 may then be taken onto the front from the water. Afterwards, the electromagnetic cable 690b disposed within the cylinder 690 may be manipulated to move the magnetic air balls 903 filled in the horizontal buoyant bodies 700 into the bellows floating body 600 to be stored therein. As the magnetic air balls 903 are dropped into the cylinder 690, which is attached on the bottom within the bellows floating body 600, the magnetic air balls 603 can serve as the weight 680. Here, since the gravity becomes greater than the buoyancy due to an increased weight of the vehicle body 100, the amphibious vehicle may be submerged into water.

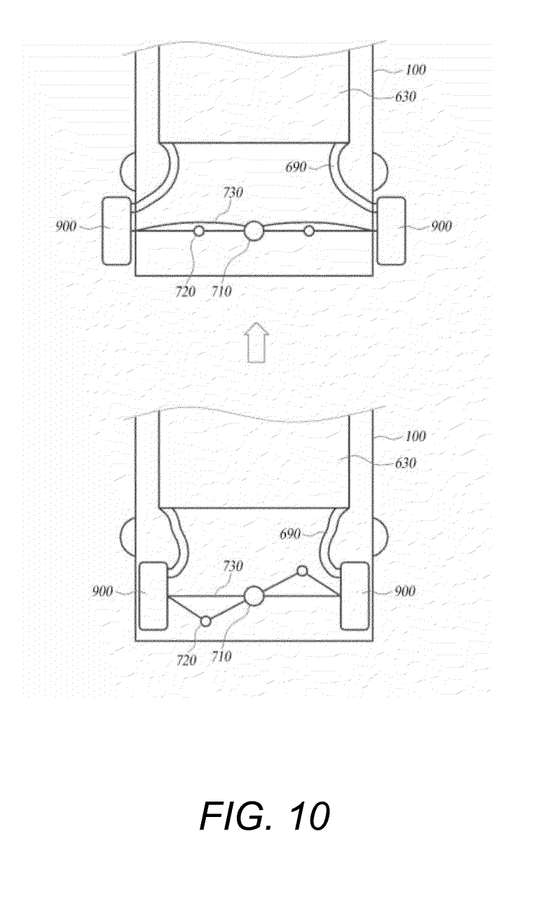

FIG. 10 is a view illustrating an operation of the horizontal buoyant bodies of the amphibious vehicle in accordance with the preferred embodiment disclosed herein. As illustrated in FIG. 10, when the cable 730 is released in response to an operation of an electric motor, the locker arms 720 connected to the horizontal buoyant bodies 700 may be unfolded, and the inlets of the horizontal buoyant bodies 700 which are located at the side surfaces of the end of the vehicle body 100 may face the top and then lowered onto water at the left and right side surfaces of the rear side of the vehicle body 100. Then, the horizontal buoyant bodies 700 may be converted into the underwater mats so as to increase an area of the buoyancy, thereby allowing the vehicle body 100 to float on the water surface.

On the other hand, when the cable 730 is rolled in response to the operation of the electric motor, the locker arms 720 which are connected to the horizontal buoyant bodies 700 may be folded. The left and right horizontal buoyant bodies 700 which are located on the water may be drawn up to the side surfaces of the rear side of the vehicle 100. The inlets of the horizontal buoyant bodies 700 may be rotated by 180° by the pulleys 710 connected thereto via the cable 730, so as to face the down. Accordingly, the magnetic air balls 903 filled in the horizontal buoyant bodies 700 may be dropped down and then stick to the electromagnetic cable 690b which are located lower than the inlets of the horizontal buoyant bodies 700, thereby being moved into the bellows floating body 600. Here, when a current flowing along the electromagnetic cable 690b is cut off at the inlet of the bellows floating body 600, the electromagnetic cable 690b may lose the magnetic force. Accordingly, the magnetic air balls 903 may be separated from the electromagnetic cable 690b so as to be dropped into the bellows floating body 600. The magnetic air balls 903 may thus be filled in the vehicle body 100. The vehicle body 100 may be affected by the great gravity, so as to be submerged.

Meanwhile, in order to move the bellows floating body 600 from a center of the vehicle body to up and down, a front-wheel drive vehicle which does not need a drive shaft and a transmission (a device of changing a rotation speed or a rotational force of a rotation shaft in various types of motors) may be used. While the bellows floating body 600 is mounted below the side sill panel 150 of the vehicle body 100, the vehicle body 100 may be increased by a height of the bellows floating body 600, such that an underwater ladder 901 can be attached to the side surface of the vehicle body. Then, an oil barrel 912 may be disposed at a position similar to a driver seat to be avoided from being sunk in water. Accordingly, the vehicle can be used as an open-roofed car.

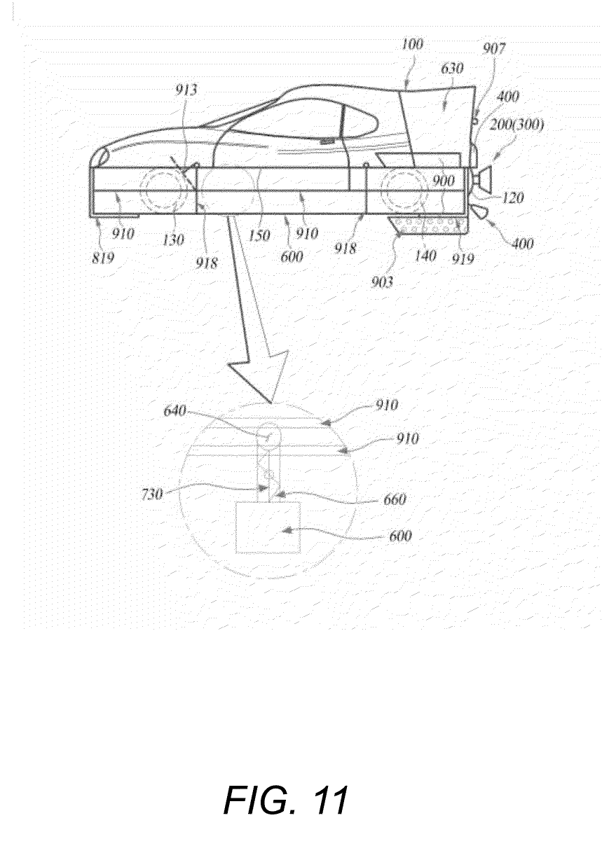

While the paddle sole robot 800 is walking, as illustrated in FIG. 11, the front paddle sole legs 802 and the rear paddle sole legs 802 which are located at front surfaces of left sides of the cross-shaped adsorption plates may be simultaneously moved with crossing each other. Also, the rear paddle sole legs which are located at rear surfaces of left sides of the other cross-shaped adsorption plates and the front and rear paddle sole legs which are located at right sides of the cross-shaped adsorption plates may be fixed.

Among the adsorption plates which are freely movable back and forth and connected in the form of a cross, while one plate is moved, three adsorption plates which are attached onto the other plate may stick to the bottom surface of the bellows floating body, allowing the robot body to be held thereon.

The paddle sole which climbs the ceiling and the walls be provided with a thin, firm paddle. The paddle (sole) sticks on the magnetic member 806, like an adhesive stuck to the wall surface. Thus, the robot may not be dropped even if being hung upside down. This paddle may be changed into small paddles which become thinner toward a top thereof and bendable. The paddle may have a wide shape like a spatula, and be provided with fine metal brushes in a shape of a spatula.

An extremely small machine may be used to erect the small paddle in horizontal and vertical shapes such that the paddle can be separated out. It seems like a tape stuck to a wall surface is torn off in a perpendicular direction. When every fine paddle comes in contact simultaneously, those paddles may have an adhesive strength to the magnetic member.

The paddle sole robot 800 may move in a manner of emitting ultrasonic waves and detecting wavelengths which are returned by being bumped against an object. The paddle sole robot 800 may have a strong adhesive force which allows the robot 800 to be hung upside down even from the ceiling, by virtue of the fine paddles and magnetic member thereof.

Here, eight paddle sole legs 802 and two paddle palm arms 804 may be provided, such that the cross-shaped adsorption plates can be moved and stopped or reduce speed at a desired position.

Therefore, a super strong bond paddle sole 801 may be made into a small robot, thereby developing a unique paddle sole robot which can move along a perpendicular wall surface or the ceiling, like walking on the ground. Here, when the fine paddle sole 801 is pressed onto the wall surface in parallel after contacting the wall surface in a perpendicular direction, the highest adhesive force may be obtained. To tear off the paddle sole 801, the fine paddle sole 801 may be erected perpendicularly to be dropped. A radio-controlled infrared sensor may be used to control power supplied to the eight paddle sole legs 802. The paddle sole legs 802 may move back and forth by converting a rotary motion of the motor into a leg motion. Also, the moving direction of the paddle sole legs 802 may be adjusted by rotating the right and left motors at different speeds. A very high adhesive force may be provided downwardly at a contact position where the paddle sole leg contacts the wall surface. When the paddle sole leg is torn off in the perpendicular direction to the wall surface, the adhesive force may be very weak.

Two pairs of the paddle sole legs 802 as a bundle of front and rear legs may be provided at a left side from a center of the paddle sole robot 800 (cross-shaped adsorption plate), and two pairs of the paddle sole legs 802 as a bundle of front and rear legs may also be provided at a right side from the center of the robot 800.

The front and rear legs of the paddle sole leg 802 may be moved by being connected to each other in such a manner that the rear legs of the paddle sole leg 802 may simultaneously be pushed when the front legs located at the left side of the cross-shaped adsorption plate are pulled, and the front legs of the paddle sole leg 802 may also simultaneously be pushed when the rear legs of the paddle sole leg 802 are pulled. Simultaneously, a chassis located on an upper surface of the front paddle sole leg of the left side of the cross-shaped adsorption plate and a chassis located on an upper surface of the rear paddle sole leg of the left side of the cross-shaped adsorption plate may be connected by small locker arms 720 so as to be movable by a continuous operation upon a robot walking

Also, applying the same structure equally to the right side of the cross-shaped adsorption plate, front legs of the right paddle sole leg 802 located at the left side of the cross-shaped adsorption plate and rear legs of the left paddle sole leg 802 may be connected to be movable along with each other, and also left front legs and right rear legs may be connected to operate along with each other.

Simultaneously, the paddle palm arms 804 which are installed at the left and right sides of the robot head may be fixed to the robot heat adsorption plate, and be horizontally movable as left and right paddle palms 803 go forward in horizontal and vertical directions.

Also, each paddle palm arm which is provided at the robot head adsorption plate and has a pair of left and right palms may operate a saw-toothed wheel of a motor, by which the right palm of the paddle palm arm can be simultaneously pushed when the left palm provided on the adsorption plate is pulled.

This employs a power transfer principle using the saw-toothed wheel 807 of the motor and a principle of converting a circular motion into a linear motion. Also, those principles may be preferably used even in order to convert the circular motion into a zigzag linear motion.

According to a position of a screw recess 808 in which a screw is inserted, a moving length or angle may differ, and the saw teeth may exhibit a speed difference, like a watch having a second hand and a hour hand moving at different speeds.

Hereinafter, description will be given of an operation of an amphibious vehicle according to the preferred embodiment with reference to the accompanying drawing.

When an operator turns on a water driving switch provided on the manipulation panel 900, a power take-off (PTO) gear 906 which is connected to a main shaft gear of a front-wheel engine may be driven, such that the pair of piston propellers 200 and 300, the steering keys 400, the front wing rod part 500, the bellows floating body 600, and the horizontal buoyant bodies 700 may be activated. When a land driving switch is turned on, a power conversion connection of the PTO gear 906 may be disconnected, such that the pair of piston propellers 200 and 300, the steering keys 400, the front wing rod part 500, the bellows floating body 600, and the horizontal buoyant bodies 700 may be deactivated.

First, the pair of piston propellers 200 and 300 may operate with crossing with each other to push back water on a water surface while they move from up to down upon rotation in one direction.

That is, when the pair of motors 210a, 210b, 310a and 310b generates a preset driving force according to the control of the manipulation panel 900, the first and second crankshafts 270a, 270b, 370a and 370b may be rotated in a predetermined direction by the operation of the first and second motors 210a, 210b, 310a and 310b. Here, the first and second connecting rods (not illustrated) may be connected and fixed to the first and second crankshafts 270a, 270b, 370a and 370b, respectively, so as to convert the rotary motion of the first and second crankshafts 270a, 270b, 370a and 370b into a linear motion. Here, the first and second cylinders 250 and 350 may be connected and fixed to end portions of the first and second connecting rods, respectively, to form linear reciprocating paths of first and second pistons each of which executes a linear reciprocating motion. The first and second laminar flow forming coils 260 and 360 may generate a magnetic flux in a predetermined direction for stabilizing a surrounding turbulent flow into a laminar flow. The electric heater 914 and the tourmaline 915 which are mounted on a circular frame of the front wing rod part 500 may increase temperature of water therearound, to generate heat in up and down directions.

Also, the steering keys 400 may steer a travel direction of the vehicle body according to a user's control. That is, when the third motor 410 generates a preset driving force according to the control of the manipulation panel 900, the steering key 430a may be moved up and down in response to an operation of the third motor 410, so as to steer the travel direction of the vehicle in water.

Also, the front wing rod part 500 may extend to the front according to a user's manipulation. That is, when the fifth motor 510 generates a preset driving force according to the control of the manipulation panel 900, the front wing rod 520 may extend forward in response to the operation of the fifth motor 510. Here, the fifth laminar flow forming coil 530 may generate a magnetic flux in a predetermined direction to stabilize a surrounding turbulent flow into a laminar flow.

The bellows floating body 600 may extend toward the front bumper 110 and the rear bumper 120 to cover the front wheels 130 and the rear wheels 140 of the vehicle. That is, when the sixth motor 610 generates a preset driving force according to the control of the manipulation panel 900, the floating body 630 may extend down by a predetermined length while being mounted in the side sill panel 150 of the vehicle body 100 by a linear reciprocating motion of the sixth motor 610, and also the bellows structure 620 may allow the bellows body 630 to extend horizontally by a preset distance in response to the operation of the sixth motor 610.

Here, when a first cable 650a provided in the floating body 630 is released in response to the operation of the sixth motor 610, the plurality of locker arms 660 may allow the floating body 630 to be moved horizontally up to the front bumper 110 and the rear bumper 120. The plurality of pulleys 640 may allow each of the locker arms 660 to be perpendicularly folded or horizontally extend. A second cable 650b may allow lower ends of the plurality of locker arms 660 to be perpendicularly folded or horizontally extend.

The horizontal buoyant bodies 700 may adjust left and right balancing of the vehicle body 100 according to the user's control. That is, the plurality of locker arms 720 may be perpendicularly folded or horizontally extend by the plurality of second pulleys 710 in a direction which is perpendicular to the proceeding direction of the vehicle body 100 by the rotating direction of the sixth motor 610. Here, the fourth cable 730 may support the plurality of locker arms 720 to be folded or extend along an outer circumferential surface of the plurality of pulleys 710.

The pair of horizontal buoyant bodies 700 may adjust submerging of the vehicle body 100 in an up and down direction according to the user's control. That is, by rotating the motor in forward and reverse directions in an alternating manner, the plurality of cables may allow the magnetic air balls 903 within the bellows floating body 600 to be taken out of the vehicle body 100. Accordingly, the horizontal buoyant bodies 700 may be converted into underwater mats so as to float on the water surface in a forward direction with respect to the proceeding direction of the vehicle body 100. The pair of horizontal buoyant bodies 700 may thus effectively stabilize buoyancy of the vehicle body 100.

As illustrated in FIG. 8, when a current flows on the electromagnetic cables 690a by an electric motor, end portions of the cables may be converted into electromagnets, and the magnetic air balls 903 which are filled in the bellows floating body 600 may be moved toward the inlet of the bellows floating body 600 by a magnetic force, so as to come in contact with the electromagnetic cables 690a. Here, since the cylinder 690 is attached on the bottom within the bellows floating body 600 and a panel is formed on the cylinder 690 in a left/right diagonal direction, the V-shaped weight 680 which gets narrower from the inlet of the bellows floating body 600 toward the bottom may be provided. The magnetic air balls 903 may be filled in the cylinder 690 attached on the bottom within the bellows floating body 600, so as to serve as the weight 680, and the center of gravity may be lowered. Accordingly, the vehicle body 100 may be restored to an original state by the law of inertia even if it is inclined in all directions due to waves.

Each magnetic air ball 903 has a circular shape and an empty space thereof is filled with air. The magnetic member 806 may be attached onto an upper end of the magnetic air ball 903. A magnetic door 902 may be installed at the inlet of the bellows floating body 600 so as to be open and closed by the magnetic force. Also, the magnetic door 902 may allow the magnetic air balls 903 to be shut in the bellows floating body 600. The magnetic air balls 903 may be filled in the bellows floating body 600 to increase a buoyant performance of the bellows floating body 600. Also, even if the vehicle body is sunk or submerged in water, the bellows floating body 600 may not have any empty space, in which water is introduced, due to the buoyancy of the magnetic air balls 903 within the bellows floating body 600. This may result in maintaining the buoyant performance in the state prior to being suck or submerged.

Several embodiments of the present invention have been described. Nevertheless, it will be understood that various modifications is made without departing from the spirit and scope of the invention. Accordingly, other embodiments are within the scope of the following claims.

What is claimed is:

1. An amphibious vehicle comprising:
a pair of piston propellers that are mounted on a lower surface of a rear bumper of a vehicle body, and configured to operate with crossing each other to push back water on a water surface while moving from up to down upon a rotation in one direction;
a pair of a first and a second motors that are configured to generate preset driving forces, respectively, according to a control of a manipulation panel installed in the vehicle body;
a first and a second crankshafts that are rotated in a predetermined direction, in response to operations of the pair of the first and the second motors; and
a first and a second cylinders that are connected and fixed to end portions of the first and the second connecting rods, respectively, and configured to form linear motion paths of the first and the second pistons executing linear reciprocating motions.

2. The vehicle of claim 1, further comprising:
a bellows floating body that is mounted between front wheels and rear wheels of the vehicle body which are located at a bottom of a side sill panel of the vehicle within the vehicle according to a user's control, and extends toward a front bumper and the rear bumper to cover the front wheels and the rear wheels of the vehicle;
a third motor that is configured to generate a preset driving force according to the control of the manipulation panel;
a floating body that extends downward by a predetermined length in a state of being mounted in the side sill panel of the vehicle body, in response to a linear reciprocating motion of the third motor;
a bellows structure that is installed in the floating body, and configured to extend the floating body horizontally by a preset distance, in response to an operation of the third motor;
a first cable that is rolled or unrolled by the operation of the third motor;
a plurality of locker arms that are configured to move the floating body horizontally up to the front bumper and the rear bumper when the first cable is unrolled;
a plurality of pulleys that are installed between the plurality of locker arms and configured to perpendicularly fold or horizontally extend each of the plurality of locker arms;
a second cable that is configured to fold or extend the plurality of locker arms along outer circumferential surfaces of the plurality of pulleys, in response to the operation of the third motor;
a fourth motor that is installed on an outer upper end of the bellows floating body, and configured to generate a preset driving force according to the control of the manipulation panel;
a pair of locker arms that are installed at an inner center of the bellows floating body in a direction perpendicular to the proceeding direction of the vehicle body, are located in the bellows floating body and a pair of horizontal buoyant bodies, which adjust left and right balancing of the bellows floating body according to the user's control, and are perpendicularly folded or horizontally extend by a plurality of second pulleys in a direction perpendicular to the proceeding direction of the vehicle body by a rotation direction of the third motor;
a third cable that is configured to support the plurality of locker arms when the locker arms are folded or extend by the plurality of pulleys;
a pair of horizontal buoyant bodies that are fixed to both ends of the third cable, and configured to adjust a horizontal balance of the bellows floating body; and
a pair of fourth cables that are installed at front and rear ends of the bellows floating body, respectively, and configured to support the bellows floating body.

3. The vehicle of claim 1, further comprising;
a paddle sole robot that is formed thin and firm on each paddle sole of a cross-shaped adsorption plate, and is changed into a small paddle which becomes thinner toward a top thereof and bendable;
a third motor that is configured to generate a preset driving force according to the control of the manipulation panel;
a first cable that is configured to allow fine paddles provided at the paddle sole robot and the paddle sole robot to horizontally move by an inductive cable and a magnetic member provided on the bottom of the bellows floating body and centers of side members;
paddle sole legs and paddle soles that are provided on a cross-shaped adsorption plate and extend with crossing a bottom of the vehicle body back and forth such that the paddle sole robot is horizontally moved when the first cable is unrolled;
at least one paddle palm arm and paddle palm that are provided on a robot head adsorption plate; and
a first saw-toothed wheel that is configured to connect and move the paddle sole legs located at left and right sides of cross-shaped adsorption plates of the paddle sole robot, each paddle sole leg having front and rear legs as a pair provided on the cross-shaped adsorption plate, in such a manner that the rear legs of the paddle sole legs are simultaneously pushed when the front legs provided on the cross-shaped adsorption plates are pulled and the front legs of the paddle sole legs are simultaneously pushed when the rear legs of the paddle sole legs are pulled.

4. The vehicle of claim 2, further comprising:
a pair of horizontal buoyant bodies that are installed respectively at left and right side surfaces of a rear end, and configured to adjust a weight by filling magnetic air balls in the bellows floating body and to adjust buoyancy by taking the magnetic air balls out of the bellows floating body, wherein the horizontal buoyant bodies are drawn down and converted into underwater mats;
a motor that is configured to generate a preset driving force according to the control of the manipulation panel;
one or more magnetic air balls that are moved up and down, in response to an operation of the motor, and located in the horizontal buoyant bodies adjusting gravity and buoyancy of the vehicle;
a plurality of electromagnetic cables that are configured to reciprocate the magnetic air balls from the bellows floating body to the horizontal buoyant bodies and from the horizontal buoyant bodies to the bellows floating body;
a ring that is configured to separate the magnetic air balls located on the electromagnetic cable;
a pair of electric electromagnets that are configured to connect an inlet of the bellows floating body and inlets of the horizontal buoyant bodies via cylinders, wherein the pair of electromagnets generate magnetism when a current flows thereon and are converted into an original state when the current is cut off;
a plurality of cables that are configured to move the horizontal buoyant bodies down to side surfaces of the vehicle body to be moved in up and down directions such that the horizontal buoyant bodies are converted into the underwater mats; and
a pair of horizontal buoyant bodies that are configured to adjust horizontal buoyancy of the vehicle body.
